(19) United States
(12) Patent Application Publication
(10) Pub. No.: US 2025/0387729 A1
(43) Pub. Date: Dec. 25, 2025

(54) SCRAPED-SURFACE SALT SEPARATOR WITH A SCRAPER PLATE WHICH SLIDES INTO A PRECIPATED-SALT RESOLUBILIZATION ZONE AND ASSOCIATED BIOMASS GASIFICATION FACILITY

(71) Applicant: COMMISSARIAT A L'ENERGIE ATOMIQUE ET AUX ENERGIES ALTERNATIVES, Paris (FR)

(72) Inventors: Frédéric DUCROS, Grenoble Cedex (FR); Hary DEMEY CEDENO, Grenoble (FR); Olivier GILLIA, Grenoble (FR)

(21) Appl. No.: 18/881,100

(22) PCT Filed: Jul. 4, 2023
(86) PCT No.: PCT/EP2023/068367

§ 371 Date: Jan. 3, 2025

(30) Foreign Application Priority Data
Jul. 4, 2022 (FR) FR2206788

(51) Int. Cl. B01D 9/00; B01D 21/00; B01D 21/04; C02F 1/00; C02F 11/18; C10J 3/78

(52) U.S. Cl. CPC B01D 9/0031; B01D 21/0012; B01D 21/009; B01D 21/04; C02F 1/001; C02F 11/18; C10J 3/78; C10J 2300/0903; C10J 2300/0916; C10J 2300/1246; C10J 2300/169

(57) ABSTRACT

A separator for salts contained in a solution which is brought under supercritical conditions, with at least one salt filter which can retain therein salts initially contained in the solution and which are precipitated, including those in the form of micro- or nanoparticles. The operation of the salt separator makes it possible, if necessary, to heat the solution for conversion to a temperature ensuring the precipitation of the salts and their retention within suitable filters and then to separate the solution for conversion into a salt-depleted stream which is discharged from the separator and directed to a conversion reactor, in particular a gasification reactor, and, if appropriate, into a stream loaded with salts to be extracted in the form of a brin.

### TECHNICAL FIELD

The present invention relates generally to salt separators and more particularly to those intended to be used in a facility for thermochemical conversion of a feedstock of carbonaceous material, notably under supercritical fluid, for the production of a gaseous mixture.

“Feedstock of carbonaceous material” is understood to mean, here and in the context of the invention, any material containing a quantity of carbon, in particular any carbonaceous material of residues.

It can therefore be biomass, that is to say any non-homogeneous carbon-containing material of plant origin, such as lignocellulosic biomass, forestry or agricultural residues (straw), which can be virtually dry or impregnated with water such as household waste or waste resulting from water purification such as treatment plant sludge.

It can also be a fuel of fossil origin, such as coal.

It can also be combustible waste of industrial origin, in particular from the agri-food industry, that contains carbon, such as plastics or used tires, used oils, organic solvents.

It can also be a combination of biomass and of fuel of fossil origin.

“Supercritical fluid” is understood, here and in the context of the invention, in the conventional sense, namely as meaning a pressure and a temperature beyond which the fluid is in a supercritical state. Its behavior becomes intermediate between the liquid state and the gaseous state: its density is that of a liquid, but its low viscosity resembles that of a gas.

Thus, “supercritical water” is understood in the conventional sense, that is to say as meaning water at temperatures greater than 374° C. under a pressure greater than 22.1 MPa.

Although described with reference to a preferred application for gasification of a feedstock of carbonaceous material under supercritical water, a salt separator according to the invention can be used in numerous applications, and particularly in the industrial fields of agri-food, chemistry, energy, including the oil sector and the transport sector, for which separation of salts from an aqueous fluid mixture is required.

Generally, a salt separator according to the invention is suitable for separating salts that are initially present in aqueous solutions with or without organic material.

More specifically, a salt separator according to the invention is advantageously used in a facility for thermochemical conversion of wet carbonaceous resources, such as supercritical water gasification.

### PRIOR ART

A large number of existing processes make it possible to convert, via the thermochemical route, a carbonaceous feedstock into liquid fuels (biofuels, biochar), solid fuels (granules) and gaseous fuels (biogas, methane, syngas, hydrogen).

Among these, the gasification of biomass and coal has been known for a long time. Generally, it can be defined as a thermochemical conversion of biomass or coal by the action of heat in the presence of gasifying agents. The aim is to generate, at the end of the gasification, a gas mixture.

Thus, the gasification processes for lignocellulosic biomass make it possible to generate a gas that is rich in methane or hydrogen.

The separation and the recovery of inorganic constituents present in the feed stream of the reactors which implement these thermochemical processes are crucial, because these constituents can lead to blockage of the facility, to fouling and to poisoning of the gasification catalyst. In addition, the recovery of salts offers the possibility of producing a fertilizer as valuable byproduct.

Numerous articles in the literature show that the separation of salts in a thermochemical conversion process is of great importance for the actual effectiveness of the overall process and for the service life of the related facility. Nevertheless, the drawback of known salt separators hitherto is that the separation of salt is still not satisfactory or, although satisfactory, requires excessively high inputs of thermal or mechanical energy or that the salts are combined with a significant portion of organic material. In addition, clogging and deposits are a major problem in such salt separators.

More particularly, various scientific articles focus on the dynamics of the salt precipitation in supercritical hydrogenation conditions, which makes it possible to separate salts that are initially present from an aqueous solution containing an organic material.

FIG. 1 reproduces a salt separator as disclosed in publication [1], as envisioned for the supercritical water gasification of biomass. This separator 1 comprises, as device for injecting the biomass, a cylindrical tube 10 with an injection orifice 11 through which the biomass is injected, and an outlet orifice 12 through which the biomass is discharged into an inner chamber C delimited by an enclosure 2 with two walls 20, 21, the outer one 21 of which, which is thermally insulating, incorporates heating elements 22 which thus heat the chamber C and the injection tube 10.

When the wet biomass is introduced into the tube 10, it is gradually brought to a temperature of approximately 450° C.: the precipitation occurs virtually instantaneously as soon as the temperature reached leads to a decrease in the solubility of the salts, leading to the separation of the wet biomass into various phases, notably solid phases, in a separation zone S within the chamber C.

In the vertically installed configuration of the separator, the biomass/water/salt and other solids mixture, this separation zone S generates gravity separation into a brine that is heavily charged with salts and a salt-depleted solution. A resolubilization zone R, immediately below the separation zone S, makes it possible to resolubilize salts which are therefore discharged by gravity in the form of brine through the outlet orifice 23 pierced in the bottom 24 of the separator, without mixing with the portion of the effluents which rises in the chamber C so as to be discharged through the outlet orifice 25 to a gasification reactor (not shown).

Such gravity separators are also described in publications [2] and [3]: they are implemented for inorganic fluids and salt deposits for hydrothermal gasification. For the same application, there are also cyclone separators.

Overall, a gravity separator operates satisfactorily when the phases involved turn out to be more dense than the carrier medium and in a grain size distribution that enables gravity separation and brine-type behavior, salts that are called type I in this case.

However, in certain cases, the salts precipitate as particles which are so small (microparticles or nanoparticles) that they do not sediment.

In other cases, the gravity separation is not easy, as specified in publication [3]. Thus, the passage of the wet carbonaceous material in subcritical conditions to supercritical conditions can be accompanied by the appearance of very tacky solid phases, in the form of salts that are called type II. These type II salts can accumulate on the internal walls of the inner chamber of the separator and, where appropriate, clog the injection tube 10 of the separator as shown in FIG. 1.

To avoid such a harmful accumulation of type II salts, it is possible to envision applying known solutions, used in scraped-surface heat exchangers. Such exchangers are notably used in fouling processes, that is to say when the walls of the exchangers may be the site of fouling phenomena of the walls involved in the heat transfers, i.e. with deposition of undesirable materials.

By way of examples, the scrapers used may be rotary, for example of the endless screw or blade type, or oscillatory of the piston type, for example with plates that may or may not be annular. The scraper, whether rotary or oscillatory of the piston type, is generally actuated by an electric motor.

Scrapers for heat exchangers have in particular been envisioned for supercritical oxidation reactors, as described in U.S. Pat. Nos. 5,100,560A, 6,054,057 A and 5,461,648 A.

Patent application US 2012/214977 describes a scraper for ultrafiltration applications. Specific scrapers have also been envisioned for viscous fluids: https://www.hrsasia.co.in/heat-exchanger-specialists/scraped-surface-heat-exchanger/.

In the field of organic fluids, other antifouling solutions have already been envisioned, among which mention may be made of:
making components vibrate through pressure pulsation, as described in application US2008/0073063A1,
chemical treatments, such as the one in application CA 2119056.

All of these solutions are not suitable for the problem of accumulation of type II salts on the walls, which can moreover potentially occur on the scrapers themselves.

There is therefore a need to find a solution which makes it possible to better control the removal of salts, in particular type II salts, present in a solution, notably a solution intended to be subjected to a thermochemical conversion treatment such as wet biomass intended to be gasified.

The aim of the invention is to at least partially meet this need.

### DISCLOSURE OF THE INVENTION

To this end, the invention relates to a salt separator for separating salts from a solution containing them, the salt separator comprising:
an enclosure delimiting an inner chamber, the enclosure comprising:
   a cover through which an injection orifice is pierced, the injection orifice being intended to inject a solution containing one or more salts,
   at least one lateral wall,
   a bottom, the bottom and/or the lateral wall being pierced by at least one outlet orifice through which the solution devoid of precipitated salts is intended to be discharged;
at least one salt filter housed and fastened in the inner chamber, the salt filter being adapted to retain the salts within it, once they have been precipitated in the inner chamber, including those in the form of microparticles and nanoparticles.

The salt separator may be fastened in a permanent manner or in a removable manner in order to regenerate it by dissolution of the precipitated salts.

According to an advantageous configuration, the salt separator comprises a tube housed in the inner chamber and held at the cover, the tube comprising the injection orifice and an outlet orifice through which the solution is intended to be discharged, the salt filter being fastened in the vicinity of the outlet orifice.

According to this configuration, the bottom is preferably pierced by at least one outlet orifice through which the precipitated salts are intended to be discharged in the form of brine, the lateral wall being pierced by at least the outlet orifice through which the solution devoid of precipitated salts is intended to be discharged, the inner chamber comprising a separation zone between the solution devoid of precipitated salts and said precipitated salts.

Like the enclosure and, where appropriate, the tube, a salt filter according to the invention is advantageously produced from a metallic material adapted to the temperature and pressure operating conditions: it may be made of Inconel®, of stainless steel or others.

The salt separator may comprise heating means for heating at least part of the height of the lateral wall and/or at least part of the height of the internal wall of the tube to a temperature that is greater than or equal to the salt precipitation temperature.

For the means for heating the enclosure and/or the tube, it is possible to envision several alternatives which may be combined with one another:
external heating means arranged around the enclosure and/or the tube in order to heat the internal wall part thereof to the temperature that is greater than or equal to the salt precipitation temperature,
heating resistors, in the form of cartridges, intended to be supplied by an external electrical power source and incorporated in the thickness of the enclosure and/or of the tube in order to heat the internal wall part thereof to the temperature that is greater than or equal to the salt precipitation temperature,
a heat-transfer fluid circuit produced in the thickness of the enclosure and/or of the tube in order to heat the internal wall part thereof to the temperature that is greater than or equal to the salt precipitation temperature.

According to an advantageous embodiment variant, the salt separator comprises two salt filters housed and fastened independently in the inner chamber (C), by being separated by a partition, an inlet orifice and an outlet orifice for salt dissolution fluid opening out onto each of the two filters in such a way as to allow one to be regenerated by salt dissolution while still enabling continuous operation of the separator and vice versa.

A further subject of the invention is a biomass gasification facility comprising:
a salt separator as described above;
a gasification reactor connected to the enclosure of the salt separator so as to be fed with biomass devoid of salts.

According to an advantageous embodiment, the enclosure or, where appropriate, the tube of the salt separator incorporates, in its thickness, part of the circuit for recovering effluents obtained at the reactor outlet, as heat-transfer fluid circuit for heating the internal wall part thereof to the temperature that is greater than or equal to the salt precipitation temperature.

According to another advantageous embodiment, the temperature of the biomass at the injection orifice is lower by the order of 20° C. than the salt precipitation temperature, the temperature of the biomass at the outlet orifice of the salt separator being greater by the order of 20° C. than the salt precipitation temperature.

Advantageously, the operating temperature of the reactor is approximately 600° C. and the operating pressure of the reactor is approximately 300 bar.

Thus, the invention essentially consists in producing a salt separator for separating salts contained in a solution, preferably to be thermochemically converted, which is carried in supercritical conditions, with at least one salt filter which can retain within it salts which are initially contained in the solution and which are precipitated, including those in the form of microparticles or nanoparticles.

The operation of the salt separator makes it possible, where appropriate, to heat the solution to be converted to a temperature that ensures the precipitation of salts and their retention within suitable filters, and then to separate the solution to be converted into a salt-depleted stream which is discharged from the separator so as to be directed to a conversion reactor, notably a gasification reactor, and, where appropriate, into a stream charged with salts to be extracted in the form of a brine.

Other advantages and features will become more clearly apparent on reading the detailed description given by way of non-limiting illustration with reference to the following figures.

### BRIEF DESCRIPTION OF THE DRAWINGS

FIG. 1 is a schematic view in longitudinal section of a salt separator according to the prior art.

FIG. 2 is a perspective view of a salt separator incorporating a precipitated-salt filter according to one embodiment of the invention.

FIG. 3 is a perspective view of a salt separator incorporating a precipitated-salt filter according to another embodiment of the invention.

FIG. 4 is a perspective view of a salt separator incorporating two independent salt filters according to another embodiment of the invention.

FIGS. 5A, 5B, 5C, D illustrate, in top view, the continuous operation of a salt separator according to FIG. 4.

FIG. 6 is a synoptic view of a wet-biomass gasification facility incorporating a salt separator incorporating a precipitated-salt filter according to the invention.

### DETAILED DESCRIPTION

For the sake of clarity, identical elements are denoted by the same numerical references according to the prior art and according to the invention.

It is specified that throughout the application the terms “inlet”, “outlet”, “upstream”, “downstream” are to be understood in relation to the direction in which the fluid in question flows within a salt separator and a gasification facility according to the invention.

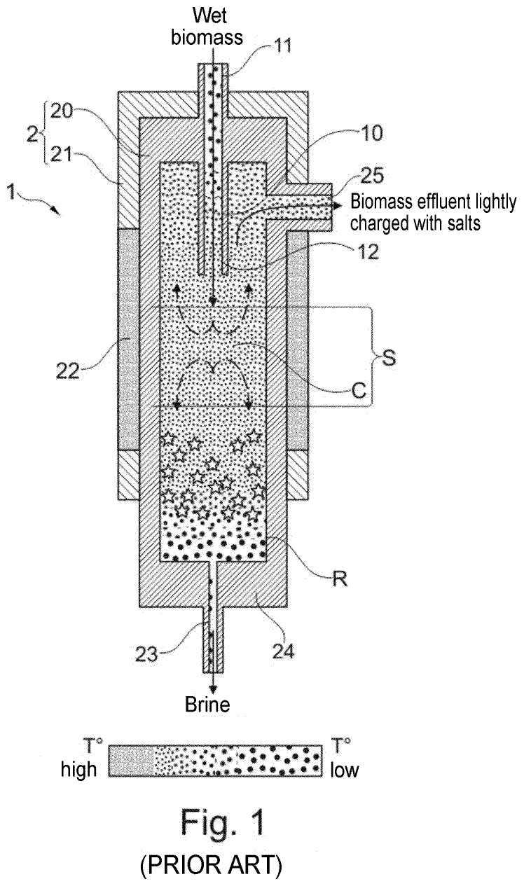

FIG. 1, which relates to a salt separator according to the prior art, has already been commented on in the preamble. It will therefore not be commented on again below.

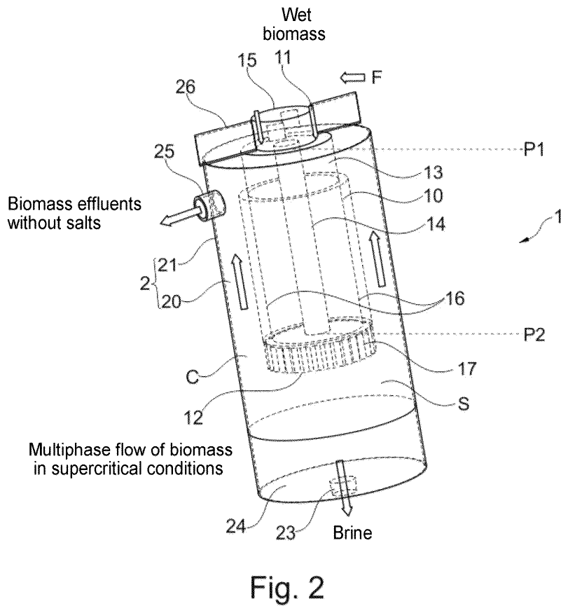

FIG. 2 shows a salt separator 1 according to one embodiment of the invention. In the example illustrated, the salt separator 1 is of axisymmetric shape of revolution. In its installed configuration, it extends vertically.

This separator 1 firstly comprises a tube 10, typically made of metal.

The tube 10, of cylindrical shape in the example illustrated, comprises an injection orifice 11 through which the wet biomass containing salts is injected, and an outlet orifice 12 through which it is discharged.

The separator 1 also comprises an enclosure 2 around the tube 10. This enclosure 2 delimits an inner chamber C, including a separation zone S for separating the precipitated salts into which the outlet orifice 12 of the tube 10 opens out.

The cover 26 of the enclosure is pierced by the injection orifice 11.

The enclosure 2 is a metallic double-wall 20, 21 enclosure, which is pierced by one or more outlet orifices 25 through which the biomass without the precipitated salts is intended to be discharged.

The bottom 24 of the enclosure is, for its part, pierced by an outlet orifice 23 through which the precipitated salts are intended to be discharged in the form of brine.

A scraper plate 13 is slidingly mounted in the tube 10 and in the inner chamber C of the enclosure along a path which generates scraping friction directly with the internal wall of the tube 10 and/or with any solid material deposit, including the precipitated salts, liable to form on top.

The scraper plate 13 is pierced by one or more orifices in order to allow the solution to pass through.

Preferably, the operation of separator is provided such that the path of the scraper plate 13 effects back-and-forth movements at least over the entire internal wall of the tube 10 in order to there scrape off any solid material deposit including the precipitated salts.

More specifically, in the example of FIG. 2, the scraper plate may assume, outside of the heated internal wall part of the tube 10, a first extreme position P1 in the vicinity of the injection orifice 11 and a second extreme position P2 in the vicinity of the outlet orifice 23 through which the precipitated salts are intended to be discharged in the form of brine.

FIG. 2 illustrates an advantageous variant of mechanical sliding means for the scraper plate 13. A screw 14 is arranged axially inside the tube 10 and the scraper plate 13 is screwed onto this screw in order to constitute an endless screw. In order to transform the rotation of the screw 14 into translation of the scraper plate 13, the latter is guided in translation by two guide rails 16 which extend parallel to one another and are held at the height of the tube 10 in notches provided for this purpose in the bottom 24 of the enclosure.

FIG. 2 also illustrates an advantageous variant of mechanical means for setting the screw 14 in rotation: its end outside of the enclosure 2 is constituted by a hydraulic turbine 15 of Pelton or Francis type which, under the action of a pressurized fluid F, brings about the rotation of the screw 14. Reference may be made to application EP3839405 for further details.

In the example of FIG. 2, the tube 10 is not heated and the wet biomass 15 is introduced at a salt precipitation temperature, meaning that the salts present in the wet biomass can precipitate as soon as they are injected into the tube 10.

Among these precipitated salts, some of those precipitated are in the form of microparticles and/or nanoparticles. However, such nanoparticles prevent pure gravity separation from being carried out.

Thus, according to the invention, a salt filter 17 is housed and fastened at the end of the tube 10, in the vicinity of the outlet orifice 12. This filter 17 is adapted to retain the precipitated salts within it, including those in the form of microparticles and nanoparticles. Such a filter 17 is made of a metallic alloy suitable for the temperature constraints of the biomass to be converted. It may be a stainless steel or Inconel®. It may be produced by additive manufacturing techniques or by brazing or others. The developed surface of a filter 17 is very large and can be obtained by way of fins, inserts, grooves, or 3D topologies resulting from additive manufacturing techniques.

Thus, the collected precipitated salts are retained within a filter 17 during the passage of the wet biomass at a temperature greater than the salt precipitation temperature.

Once it has exited the filter 17, the biomass to be converted is then in the gravity separation zone S; the brines are discharged through the outlet orifice 23, the biomass without salt through the outlet orifice 25.

To regenerate the filter 17, the operation of the separator 1 is stopped and it is cleaned with the injection, through the injection orifice 11, of a fluid that enables the dissolution of the precipitated salts. By way of example, the fluid may be water at a suitable subcritical temperature, for example 300° C., or a mixture of water and of acid solutions enabling rapid dissolution kinematics.

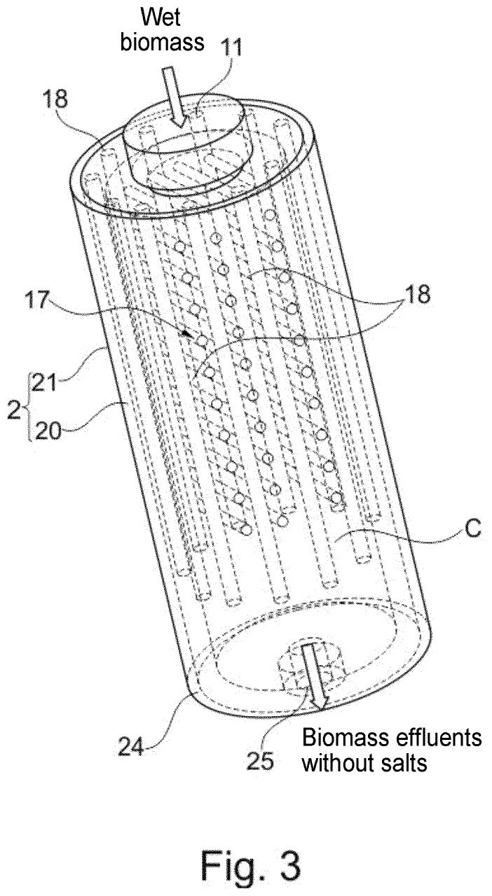

FIG. 3 illustrates another embodiment of a salt separator 1 incorporating a salt filter 17 according to the invention.

In this case, the enclosure 2 incorporates neither the tube 10 nor the scraper plate 13. In this case, the salt filter 17 is housed and fastened in a removable manner inside the inner chamber delimited by the enclosure.

Heating resistors 17, in the form of cartridges, intended to be supplied by an external electrical power source are advantageously incorporated in the thickness of the metallic double wall 20, 21 of the enclosure 2 in order to heat the internal wall thereof to a temperature that is greater than or equal to the salt precipitation temperature. This may concern cylindrical cartridges of small diameter, typically equal to 3.15 mm, such as those sold by Omega: https://www.omega.fr/subsection/cartouches-chauffantes.html.

Thus, in this embodiment in FIG. 3, the wet biomass is injected at a temperature lower than the salt precipitation temperature, and the internal wall 20 of the enclosure 2 is heated by the resistors 17 to a temperature greater than said precipitation temperature.

In this case, the biomass without salts, which are retained in the filter 17, is discharged through the outlet orifice which is pierced in the bottom 24 of the enclosure 2.

To regenerate the filter 17, the operation of the separator 1 is stopped and the filter 17 is removed in order to clean it outside of the enclosure 2, by means of a fluid that enables the dissolution of the precipitated salts.

In the case of a filter 17 that is deemed to be excessively worn or in order to not stop the operation of the salt separator 1 for an excessively long time, another filter 17 that has already been regenerated can be put in place rapidly.

The operation of the salt separators according to the embodiments illustrated in FIGS. 2 and 3 therefore involves maintenance phases, that is to say stoppage of the operation of the separator with cleaning of the filter 17, in situ in the separator or outside thereof, by flushing for example with a liquid (water and/or acids) that accelerates the dissolution of the precipitated salts retained within the filter 17.

However, it may be desirable, in applications with continuous operation, to not have to stop the operation of the separator.

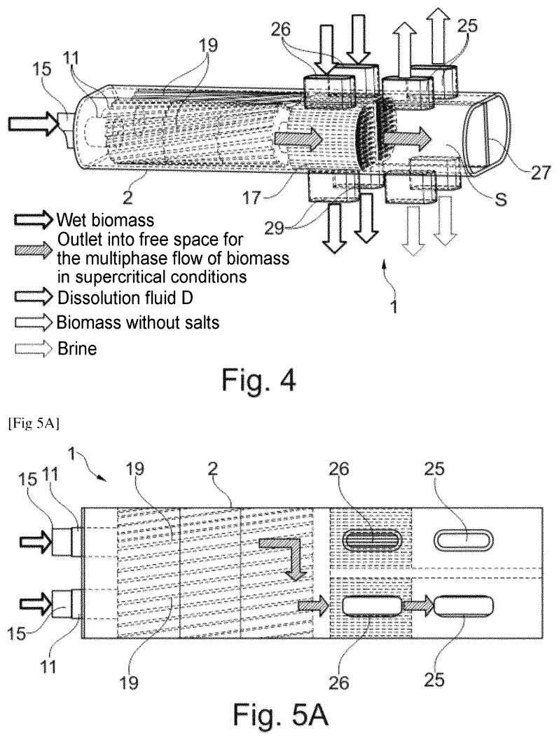

FIG. 4 illustrates a salt separator 1 which can operate continuously. The separator 1 incorporates within its enclosure 2 two salt filters 17 that are independent of one another, housed in two parallel fluid circuits and separated by means of a separation partition 27. The mounting of the independent filters 17 can make it possible to alternatingly operate one of the filters 17 while the other is being cleaned. To do so, two independent circuits for salt dissolution fluid D are each provided with an inlet orifice 28 on one side of the filter 17 and an outlet orifice 29 on the opposite side.

Furthermore, in this illustrated example, upstream of the independent salt filters 17, two rotors 19 in the form of rollers with helical toothing are mounted meshing with one another in the enclosure, the internal wall of which is of a shape delimited by two half cylinders connected to one another by a straight parallelepiped. The rotation of these meshing rotors 19 in the enclosure 2 generates spaces of variable volumes which push the wet biomass from the injection orifice 11 to the outlet orifice 12 immediately upstream of the salt filters 17, while generating scraping friction of the rotors directly with the internal wall of the enclosure 2 and/or with any solid material deposit, including the precipitated salts, liable to form.

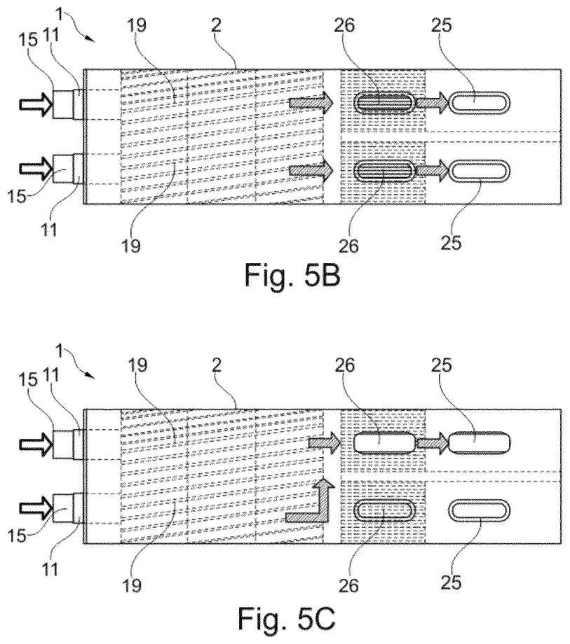

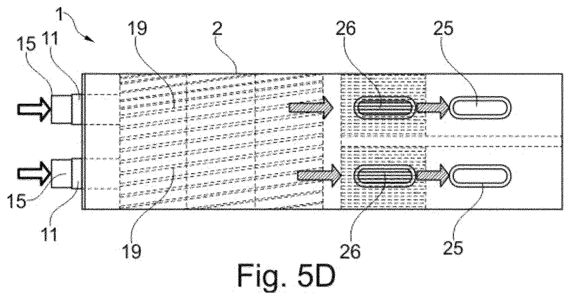

The alternating operation of this salt separator 1 with two filters 17 is now explained with reference to FIGS. 5A to 5D, the separator 1 being arranged horizontally. It is specified that the legends in these figures are the same as those in FIG. 4, the black rectangles symbolizing the closure of the orifices.

To regenerate one of the two salt filters 17, the outlet orifices 23, 25 of the fluidic circuit, situated on the side of the separation partition 29, are closed, and the filter is cleaned by injecting a salt dissolution fluid into the orifice 28, which is discharged through the outlet orifice 29. At the same time, the outlet orifices 23, 25 of the other circuit are open and the orifices for the dissolution fluid D are closed (FIG. 5A).

Once this salt filter 17 has been regenerated, the separator can operate with these two streams in parallel, only the orifices 28, 29 for the dissolution fluid being closed (FIG. 5B).

The other of the two salt filters 17 is then regenerated, in a similar way as has been effected for the first regeneration but inverting the openings/closures of orifices (FIG. 5C).

Once this other salt filter 17 has been regenerated, the separator can again operate with these two streams in parallel, only the orifices 28, 29 for the dissolution fluid being closed (FIG. 5D).

Of course, when neither of the two filters 17 requires cleaning, the separator 1 can operate with the two filters 17 in parallel and therefore simultaneous discharges of biomass effluents through the two outlet orifices 25, and of brines through the outlet orifices 23.

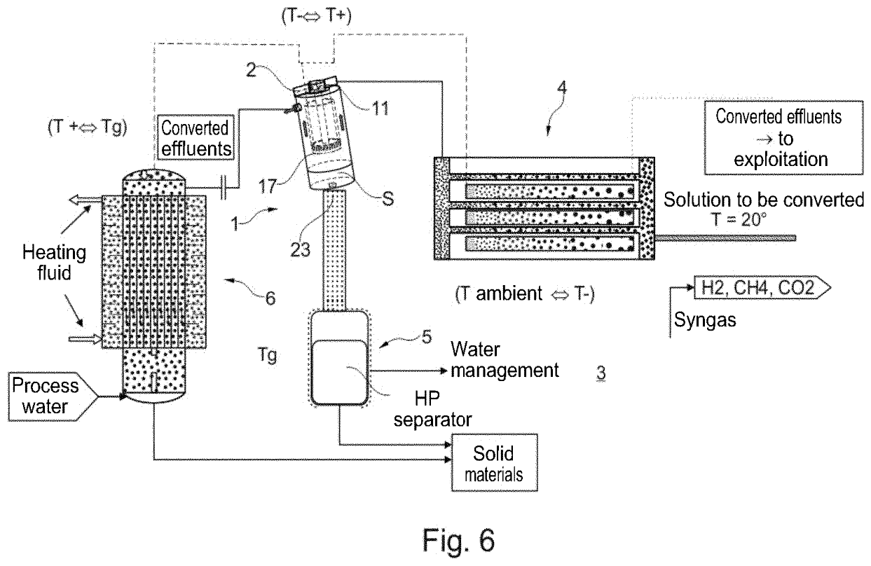

FIG. 6 illustrates a wet-biomass gasification facility 3 which incorporates a salt separator 1 according to the invention with heating means incorporated in the wall of the tube 10.

In this FIG. 6, the different symbols relating to the temperatures are the following:
T−: salt precipitation temperature, typically around 450° C., decreased by 20° C.,
T+: salt precipitation temperature, typically around 450° C., increased by 20° C.,
Tg: biomass gasification temperature, typically around 600° C.

This facility 3 comprises, from upstream to downstream in the direction in which the biomass to be gasified flows:
a heat exchanger 4, which can be standard in the management of non-tacky viscous fluid and optimized for the recovery of heat between ambient temperature and at maximum the temperature T−.
a salt separator 1, connected downstream of the heat exchanger 4, which makes it possible to pass from T− to T+ and to discharge the biomass effluents without salts while separating the salts in the form of brine,
a high-pressure separator 5, connected downstream of the separator 1, for separating the precipitated salts in solid form from the brine water,
a gasification reactor 6, connected downstream of the salt separator 1, for gasifying the biomass without salts at the temperature Tg.

The gasification reactor 6 is typically a shell-and-tube reactor and operates at 600° C. under a pressure of 300 bar.

In this figure, the solid lines symbolize the streams of material prior to gasification, respectively at a cold (ambient) temperature at the inlet of the exchanger 4, at a temperature close to T−/T+ at the outlet of the exchanger 4, then at the required gasification temperature Tg from the outlet of the separator 1.

The dashed lines represent, for their part, the streams of material post-gasification which exit the reactor at the temperature Tg, pass into a heating circuit within the envelope 2 at this temperature Tg, in order to heat the biomass entering the separator 1, then pass back into the heat exchanger 4 in order to be cooled.

As specified in this FIG. 6, once they have been cooled, the effluents converted by the gasification (syngas) are discharged from the facility 3 to a process for storage or for direct exploitation.

Other variants and improvements may be envisioned without however departing from the scope of the invention.

If, in the example illustrated in FIG. 2, the tube is not heated and the wet biomass is already introduced into the salt separator at a temperature beyond the salt precipitation temperature, it is also possible to envision heating of the tube, like in the example of FIG. 3.

If, in the example of FIG. 4, the salt separator comprises two salt filters that are independent of one another, it is possible to envision a greater number of filters with fluidic circuits for biomass in parallel with one another.

### LIST OF CITED REFERENCES

[1]: “A novel salt separator for the supercritical water gasification of biomass”, J Reimer, G. Peng, S. Viereck, E. De Boni, J. Breinl, F. Vogel, J. of Supercritical Fluids 117 (2016) 113-121.
[2]: “Continuous salt precipitation and separation from supercritical water. Part 1: Type 1 salts”, Martin Schubert, Johann W. Regler, Frederic Vogel, J. of Supercritical Fluids 52 (2010) 99-112.
[3]: “Continuous salt precipitation and separation from supercritical water. Part 2. Type 2 salts and mixtures of two salts”, Martin Schubert, Johann W. Regler, Frederic Vogel, J. of Supercritical Fluids 52 (2010) 113-124.

1. A salt separator for separating salts from a solution containing them, the salt separator comprising:
an enclosure delimiting an inner chamber (C), the enclosure comprising:
a cover through which an injection orifice is pierced, the injection orifice being intended to inject a solution containing one or more salts,
at least one lateral wall,
a bottom, the bottom and/or the lateral wall being pierced by at least one outlet orifice through which the solution devoid of precipitated salts is intended to be discharged;
at least one salt filter housed and fastened in the inner chamber (C), the salt filter being adapted to retain the salts within it, once they have been precipitated in the inner chamber, including those in the form of microparticles and nanoparticles.

2. The salt separator as claimed in claim 1, the salt filter being fastened in a permanent manner or in a removable manner in order to regenerate it by dissolution of the precipitated salts.

3. The salt separator as claimed in claim 1, comprising a tube housed in the inner chamber and held at the cover, the tube comprising the injection orifice and an outlet orifice through which the solution is intended to be discharged, the salt filter being fastened in the vicinity of the outlet orifice.

4. The salt separator as claimed in claim 3, the bottom being pierced by at least one outlet orifice through which the precipitated salts are intended to be discharged in the form of brine, the lateral wall being pierced by at least the outlet orifice through which the solution devoid of precipitated salts is intended to be discharged, the inner chamber (C) comprising a separation zone(S) between the solution devoid of precipitated salts and said precipitated salts.

5. The salt separator as claimed in claim 1, comprising external heating means arranged around the enclosure and/or the tube in order to heat the internal wall part thereof to the temperature that is greater than or equal to the salt precipitation temperature.

6. The salt separator as claimed in claim 1, comprising heating resistors, in the form of cartridges (18), intended to be supplied by an external electrical power source and incorporated in the thickness of the enclosure and/or of the tube in order to heat the internal wall part thereof to the temperature that is greater than or equal to the salt precipitation temperature.

7. The salt separator as claimed in claim 1, comprising a heat-transfer fluid circuit produced in the thickness of the enclosure and/or of the tube in order to heat at least the internal wall part thereof to the temperature that is greater than or equal to the salt precipitation temperature.

8. The salt separator as claimed in claim 1, comprising two salt filters housed and fastened independently in the inner chamber (C), by being separated by a partition, an inlet orifice and an outlet orifice for salt dissolution fluid opening out onto each of the two filters in such a way as to allow one to be regenerated by salt dissolution while still enabling continuous operation of the separator and vice versa.

9. A biomass gasification facility comprising:
a salt separator as claimed in one of the preceding claims;
a gasification reactor connected to the enclosure of the salt separator so as to be fed with biomass devoid of salts.

10. The facility as claimed in claim 9, the enclosure or, where appropriate, the tube of the salt separator incorporating, in its thickness, part of the circuit for recovering effluents obtained at the reactor outlet, as heat-transfer fluid circuit for heating the internal wall part thereof to the temperature that is greater than or equal to the salt precipitation temperature.

11. The facility as claimed in claim 9, the temperature of the biomass at the injection orifice being lower by the order of 20° C. than the salt precipitation temperature, the temperature of the biomass at the outlet orifice of the salt separator being greater by the order of 20° C. than the salt precipitation temperature.

12. The facility as claimed in claim 1, the operating temperature of the reactor being approximately 600° C. and the operating pressure of the reactor being approximately 300 bar.
